(19) United States
(12) Patent Application Publication
(10) Pub. No.: US 2019/0121628 A1
(43) Pub. Date: Apr. 25, 2019

(54) PREVIEWING APPLICATIONS BASED ON USER CONTEXT

(71) Applicant: FORD GLOBAL TECHNOLOGIES, LLC, Dearborn, MI (US)

(72) Inventors: Jeffrey Yizhou HU, Ann Arbor, MI (US); Michael CRIMANDO, Ferndale, MI (US); Oleg Yurievitch GUSIKHIN, Commerce Township, MI (US); Omar MAKKE, Lyon Township, MI (US); Jeffrey Brian YEUNG, Canton, MI (US)

(21) Appl. No.: 15/788,357

(22) Filed: Oct. 19, 2017

(51) Int. Cl. G06F 9/445; H04L 29/08

(52) U.S. Cl. CPC G06F 8/61; H04L 67/12; H04L 67/306; H04L 67/34

(57) ABSTRACT

A system includes a transceiver and a computing platform of a vehicle. The computing platform is programmed to display a user interface of applications executed by a mobile device connected via the transceiver, execute a preview application including a function to download a full version of the application to the mobile device, and responsive to selection of the function, send a request to the mobile device to download the full version of the application.

### TECHNICAL FIELD

Aspects of the disclosure generally relate to the providing preview version of applications according to a user context.

### BACKGROUND

A user may utilize an app store to download applications to his or her mobile device. The app store may allow for searching for applications by category, name, or popularity. However, it may be difficult for a user to learn of applications that may be relevant to him or her. Moreover, it may be tedious for the user to try out several applications before deciding on one that suits the needs of the user.

### SUMMARY

In one or more illustrative embodiments, a system includes a transceiver and a computing platform of a vehicle. The computing platform is programmed to display a user interface of applications executed by a mobile device connected via the transceiver, execute a preview application including a function to download a full version of the application to the mobile device, and responsive to selection of the function, send a request to the mobile device to download the full version of the application.

In one or more illustrative embodiments, a method includes registering a preview application installed to a vehicle responsive to contextual information of the preview application matching vehicle context including vehicle location and listing of applications downloaded to a mobile device connected to the vehicle; and responsive to selection of function of the preview application to download a full version of the application, sending a message to the mobile device to install the full version to the mobile device.

In one or more illustrative embodiments, a non-transitory computer-readable medium includes instructions that, when executed by a processor of a computing platform, cause the computing platform to download a preview application from a remote server to the computing platform; register the preview application to a vehicle responsive to contextual information of the preview application matching vehicle context including vehicle location and listing of applications installed to a mobile device connected to the vehicle; display a listing including both applications installed to the mobile device and preview applications installed to the computing platform; and responsive to selection of a function of the preview application to download a full version of the application, send a message to the mobile device to install the full version to the mobile device.

### BRIEF DESCRIPTION OF THE DRAWINGS

FIG. 1 illustrates an example diagram of a system configured to provide telematics services to a vehicle;

FIG. 2 illustrates an example data flow for the recommendation of preview applications;

FIG. 3 illustrates an example user interface of the computing platform displaying an application listing;

FIG. 4 illustrates an example user interface of the computing platform displaying a preview application alert;

FIG. 5 illustrates an example user interface of the computing platform displaying a preview application in the applications list view;

FIG. 6 illustrates an example user interface of the preview application provided by the computing platform; and

FIG. 7 illustrates an example process for providing a preview application by the computing platform.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

This disclosure relates to systems and methods for previewing third-party applications within a vehicle based on vehicle context. The vehicle context may include one or more of the following: vehicle location, vehicle make/model, applications already downloaded, weather, fuel, time, vehicle status (e.g., diagnostic codes, maintenance that is due, etc.).

To provide for application discovery, the vehicle may identify applications that the user does not have installed to his or her connected mobile device. Consequently, these identified applications cannot be utilized by the vehicle (e.g., via FORD APPLINK). These unavailable identified applications may be advertised to the user based on the vehicle context. Provided that the user allows this feature to operate on the system, the vehicle could automatically download a preview version of the application from a remote server based on the vehicle context, and save the application to the vehicle. The downloaded application could then advertise itself to the users in the vehicle. The preview application may contain a subset of the full application's features. Or, in other cases the preview application may contain substantially the same features of the application. The preview application may also include a feature to allow the user to download the full application, from a server, onto the mobile phone of the user. Accordingly, the user may be able to use the preview functionality of the vehicle to discover useful new applications that can be downloaded to the user's mobile device.

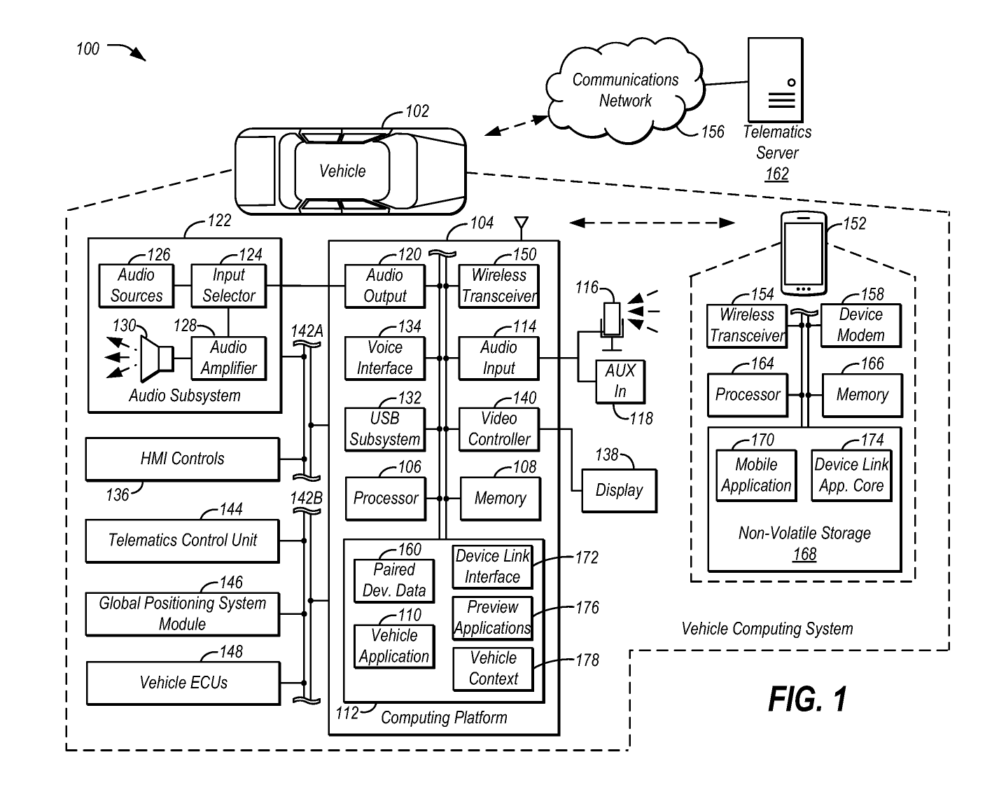

FIG. 1 illustrates an example diagram of a system 100 configured to provide telematics services to a vehicle 102. The vehicle 102 may include various types of passenger vehicle, such as crossover utility vehicle (CUV), sport utility vehicle (SUV), truck, recreational vehicle (RV), boat, plane or other mobile machine for transporting people or goods. Telematics services may include, as some non-limiting possibilities, navigation, turn-by-turn directions, vehicle health reports, local business search, accident reporting, and hands-free calling. In an example, the system 100 may include the SYNC system manufactured by The Ford Motor Company of Dearborn, Mich. It should be noted that the illustrated system 100 is merely an example, and more, fewer, and/or differently located elements may be used.

A computing platform 104 may include one or more processors 106 configured to perform instructions, commands, and other routines in support of the processes described herein. For instance, the computing platform 104 may be configured to execute instructions of vehicle applications 110 to provide features such as navigation, accident reporting, satellite radio decoding, and hands-free calling. Such instructions and other data may be maintained in a non-volatile manner using a variety of types of computer-readable storage medium 112. The computer-readable medium 112 (also referred to as a processor-readable medium or storage) includes any non-transitory medium (e.g., a tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants to interface with the computing platform 104. For example, the computing platform 104 may include an audio input 114 configured to receive spoken commands from vehicle occupants through a connected microphone 116, and an auxiliary audio input 118 configured to receive audio signals from connected devices. The auxiliary audio input 118 may be a physical connection, such as an electrical wire or a fiber optic cable, or a wireless input, such as a BLUETOOTH audio connection. In some examples, the audio input 114 may be configured to provide audio processing capabilities, such as pre-amplification of low-level signals, and conversion of analog inputs into digital data for processing by the processor 106.

The computing platform 104 may also provide one or more audio outputs 120 to an input of an audio module 122 having audio playback functionality. In other examples, the computing platform 104 may provide the audio output to an occupant through use of one or more dedicated speakers (not illustrated). The audio module 122 may include an input selector 124 configured to provide audio content from a selected audio source 126 to an audio amplifier 128 for playback through vehicle speakers 130 or headphones (not illustrated). The audio sources 126 may include, as some examples, decoded amplitude modulated (AM) or frequency modulated (FM) radio signals, and audio signals from compact disc (CD) or digital versatile disk (DVD) audio playback. The audio sources 126 may also include audio received from the computing platform 104, such as audio content generated by the computing platform 104, audio content decoded from flash memory drives connected to a universal serial bus (USB) subsystem 132 of the computing platform 104, and audio content passed through the computing platform 104 from the auxiliary audio input 118.

The computing platform 104 may utilize a voice interface 134 to provide a hands-free interface to the computing platform 104. The voice interface 134 may support speech recognition from audio received via the microphone 116 according to a standard grammar describing available command functions, and voice prompt generation for output via the audio module 122. The voice interface 134 may utilize probabilistic voice recognition techniques using the standard grammar in comparison to the input speech. In many cases, the voice interface 134 may include a standard user profile tuning for use by the voice recognition functions to allow the voice recognition to be tuned to provide good results on average, resulting in positive experiences for the maximum number of initial users. In some cases, the system may be configured to temporarily mute or otherwise override the audio source specified by the input selector 124 when an audio prompt is ready for presentation by the computing platform 104 and another audio source 126 is selected for playback.

The computing platform 104 may also receive input from human-machine interface (HMI) controls 136 configured to provide for occupant interaction with the vehicle 102. For instance, the computing platform 104 may interface with one or more buttons or other HMI controls configured to invoke functions on the computing platform 104 (e.g., steering wheel audio buttons, a push-to-talk button, instrument panel controls, etc.). The computing platform 104 may also drive or otherwise communicate with one or more displays 138 configured to provide visual output to vehicle occupants by way of a video controller 140. In some cases, the display 138 may be a touch screen further configured to receive user touch input via the video controller 140, while in other cases the display 138 may be a display only, without touch input capabilities.

The computing platform 104 may be further configured to communicate with other components of the vehicle 102 via one or more in-vehicle networks 142. The in-vehicle networks 142 may include one or more of a vehicle controller area network (CAN), an Ethernet network, and a media oriented system transfer (MOST), as some examples. The in-vehicle networks 142 may allow the computing platform 104 to communicate with other vehicle 102 systems, such as a telematics control unit 144 having an embedded modem, a global positioning system (GPS) module 146 configured to provide current vehicle 102 location and heading information, and various vehicle electronic control units (ECUs) 148 configured to cooperate with the computing platform 104. As some non-limiting possibilities, the vehicle ECUs 148 may include a powertrain control module configured to provide control of engine operating components (e.g., idle control components, fuel delivery components, emissions control components, etc.) and monitoring of engine operating components (e.g., status of engine diagnostic codes); a body control module configured to manage various power control functions such as exterior lighting, interior lighting, keyless entry, remote start, and point of access status verification (e.g., closure status of the hood, doors, and/or trunk of the vehicle 102); a radio transceiver module configured to communicate with key fobs or other local vehicle 102 devices; and a climate control management module configured to provide control and monitoring of heating and cooling system components (e.g., compressor clutch and blower fan control, temperature sensor information, etc.).

As shown, the audio module 122 and the HMI controls 136 may communicate with the computing platform 104 over a first in-vehicle network 142-A, and the telematics control unit 144, GPS module 146, and vehicle ECUs 148 may communicate with the computing platform 104 over a second in-vehicle network 142-B. In other examples, the computing platform 104 may be connected to more or fewer in-vehicle networks 142. Additionally or alternately, one or more HMI controls 136 or other components may be connected to the computing platform 104 via different in-vehicle networks 142 than shown, or directly without connection to an in-vehicle network 142.

The computing platform 104 may also be configured to communicate with mobile devices 152 of the vehicle occupants. The mobile devices 152 may be any of various types of portable computing device, such as cellular phones, tablet computers, smart watches, laptop computers, portable music players, or other devices capable of communication with the computing platform 104. In many examples, the computing platform 104 may include a wireless transceiver 150 (e.g., a BLUETOOTH module, a ZIGBEE transceiver, a Wi-Fi transceiver, an IrDA transceiver, an RFID transceiver, etc.) configured to communicate with a compatible wireless transceiver 154 of the mobile device 152. Additionally or alternately, the computing platform 104 may communicate with the mobile device 152 over a wired connection, such as via a USB connection between the mobile device 152 and the USB subsystem 132. In some examples the mobile device 152 may be battery powered, while in other cases the mobile device 152 may receive at least a portion of its power from the vehicle 102 via the wired connection.

A communications network 156 may provide communications services, such as packet-switched network services (e.g., Internet access, VoIP communication services), to devices connected to the communications network 156. An example of a communications network 156 may include a cellular telephone network. Mobile devices 152 may provide network connectivity to the communications network 156 via a device modem 158 of the mobile device 152. To facilitate the communications over the communications network 156, mobile devices 152 may be associated with unique device identifiers (e.g., mobile device numbers (MDNs), Internet protocol (IP) addresses, etc.) to identify the communications of the mobile devices 152 over the communications network 156. In some cases, occupants of the vehicle 102 or devices having permission to connect to the computing platform 104 may be identified by the computing platform 104 according to paired device data 160 maintained in the storage medium 112. The paired device data 160 may indicate, for example, the unique device identifiers of mobile devices 152 previously paired with the computing platform 104 of the vehicle 102, such that the computing platform 104 may automatically reconnected to the mobile devices 152 referenced in the paired device data 160 without user intervention.

When a mobile device 152 that supports network connectivity is paired with and connected to the computing platform 104, the mobile device 152 may allow the computing platform 104 to use the network connectivity of the device modem 158 to communicate over the communications network 156 with a remote telematics server 162 or other remote computing device. In one example, the computing platform 104 may utilize a data-over-voice plan or data plan of the mobile device 152 to communicate information between the computing platform 104 and the communications network 156. Additionally or alternately, the computing platform 104 may utilize the telematics control unit 144 to communicate information between the computing platform 104 and the communications network 156, without use of the communications facilities of the mobile device 152.

Similar to the computing platform 104, the mobile device 152 may include one or more processors 164 configured to execute instructions of mobile applications 170 loaded to a memory 166 of the mobile device 152 from storage medium 168 of the mobile device 152. In some examples, the mobile applications 170 may be configured to communicate with the computing platform 104 via the wireless transceiver 154 and with the remote telematics server 162 or other network services via the device modem 158.

For instance, the computing platform 104 may include a device link interface 172 to facilitate the integration of functionality of the mobile applications 170 configured to communicate with a device link application core 174 executed by the mobile device 152. In some examples, the mobile applications 170 that support communication with the device link interface 172 may statically link to or otherwise incorporate the functionality of the device link application core 174 into the binary of the mobile application 170. In other examples, the mobile applications 170 that support communication with the device link interface 172 may access an application programming interface (API) of a shared or separate device link application core 174 to facilitate communication with the device link interface 172.

The integration of functionality provided by the device link interface 172 may include, as an example, the ability of mobile applications 170 executed by the mobile device 152 to incorporate additional voice commands into the grammar of commands available via the voice interface 134. The device link interface 172 may also provide the mobile applications 170 with access to vehicle information available to the computing platform 104 via the in-vehicle networks 142. The device link interface 172 may further provide the mobile applications 170 with access to the vehicle display 138. An example of a device link interface 172 may be the SYNC APPLINK component of the SYNC system provided by the Ford Motor Company of Dearborn, Mich. Other examples of device link interfaces 172 may include MIRRORLINK, APPLE CARPLAY, and ANDROID AUTO.

As explained in greater detail below, the computing platform 104 may further allow for the execution of preview applications 176. The preview applications 176 are vehicle applications 110 installed to the computing platform 104 that appear in the user interface of the computing platform 104 in a similar manner to the mobile applications 170. The preview applications 176 may be downloaded to the computing platform 104 from the telematics server 162 via the embedded modem of the telematics control unit 144, or in other cases from the telematics server 162 by the mobile device 152 and passed to the computing platform 104 via the local connection between the mobile device 152 and the computing platform 104.

The preview applications 176 may be associated with vehicle context 178 information that specifies when the preview applications 176 may be recommended to the user. The vehicle context 178 may include one or more of the following: vehicle location, vehicle make/model, applications already downloaded, weather, fuel, time, vehicle status (e.g., diagnostic codes, maintenance that is due, etc.). As explained in detail below, the vehicle context 178 may be used to provide alerts to the user that there are preview applications 176 available for the current vehicle context 178.

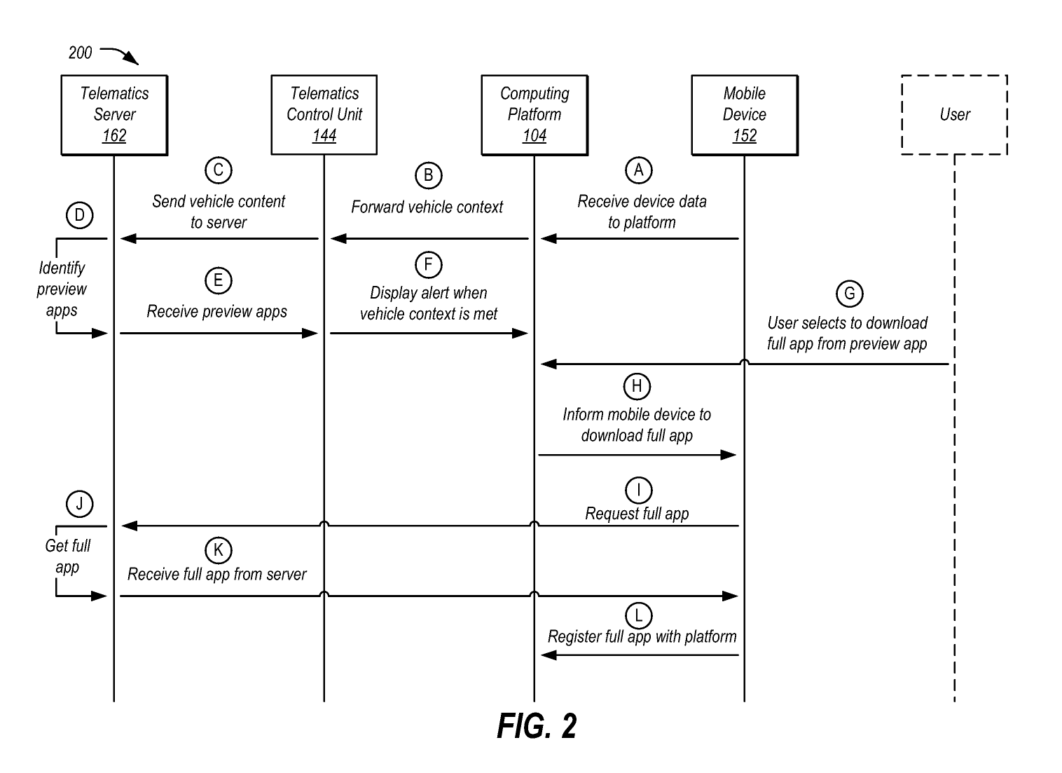

FIG. 2 illustrates an example data flow 200 for the recommendation of preview applications 176. In an example, the data flow 200 may be performed using the system 100 discussed in detail above.

At time index (A), the computing platform 104 receives device data from the mobile device 152. The device data may include information such as a listing of applications that are currently downloaded to the mobile device 152, available space on the mobile device 152, and operating system or other compatibility information of the mobile device 152. The computing platform 104 may receive the information and may add additional contextual information to the received data. As some examples, the computing platform 104 may include a current location of the vehicle 102 (e.g., determined via the global positioning system module 146), a fuel level of the vehicle (e.g., determined based on data retrieved via the in-vehicle network 142), a current time, and other vehicle status information (e.g., diagnostic codes, maintenance that is due according to mileage or wear, etc.). This compilation of data may be included as the vehicle context 178.

At time index (B), the computing platform 104 forwards the vehicle context 178 to the embedded modem 158 for transmission. At time index (C), the telematics control unit 144 sends the vehicle context 178 to the telematics server 162.

At time index (D), the computing platform 104 identifies preview applications 176 to be sent to the vehicle 102. In an example, the telematics server 162 may utilize the vehicle context 178 to identify preview applications 176 that are compatible with the mobile device 152 connected to the computing platform 104 of the vehicle 102. In another example, the telematics server 162 may utilize the vehicle context 178 to identify preview applications 176 that relate to a store or vendor within geographic proximity to the current location of the vehicle 102. In yet a further example, the telematics server 162 may utilize the vehicle context 178 to identify preview applications 176 that relate to a current need of the vehicle 102, such as that the vehicle 102 requires fuel. These identified preview applications 176 may be sent by the telematics server 162 to the vehicle 102. At time index (E), the telematics control unit 144 receives the identified preview applications 176 from the telematics server 162. The received preview applications 176 may each be associated with vehicle context 178 such that the preview application 176 is to be recommended when the vehicle context 178 of the preview application 176 matches that of current conditions.

At time index (F), the telematics control unit 144 displays an alert when the vehicle context 178 of the preview application 176 matches that of current conditions. The alert may allow the user to select to open up the preview application 176 for use. The preview application 176 may further include a function that, when selected, allows the user to download a full version of the preview application 176 to the mobile device 152.

At time index (G), the mobile device 152 receives an indication to download the full version of a preview application 176. In an example, the user may select the function of the preview application 176 to cause the full version to be downloaded. The computing platform 104 may accordingly receive the user request.

At time index (H), the computing platform 104 informs the mobile device 152 of the full application to download. The mobile device 152 may, accordingly, download a mobile application 170 corresponding to the preview application 176 installed to the telematics control unit 144. For instance, at time index (I), the mobile device 152 requests the full mobile application 170 from the telematics server 162. At time index (J), the telematics server 162 retrieves the full mobile application 170 from storage, and at time index (K), the telematics server 162 sends the full mobile application 170 to the mobile device 152. The mobile device 152, accordingly, receives the full mobile application 170 and installs the full mobile application 170 to the storage 168 of the mobile device 152. At time index (L), the mobile device 152 registers the full mobile application 170 with the computing platform 104. In an example, the mobile device 152 may provide a name, unique identifier, and/or other information regarding the full mobile application 170 to the computing platform 104. Responsive to the information, the computing platform 104 may allow the full mobile application 170 to be accessed via the HMI of the computing platform 104. For instance, the full mobile application 170 may become available in the applications list view of the vehicle HMI.

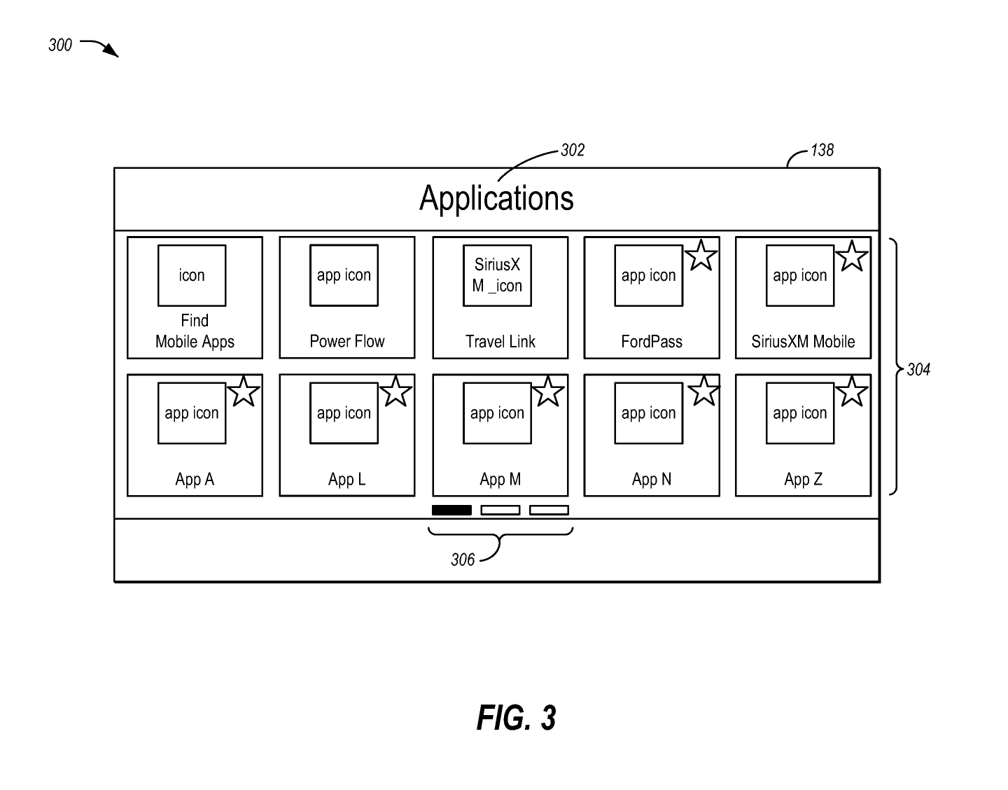

FIG. 3 illustrates an example user interface 300 of the computing platform 104 displaying an application listing 304. The user interface 300 may be presented by the computing platform 104 on the display 138. The user interface 300 may be invoked, in an example, responsive to user selection of view of the available applications from a home screen of the computing platform 104. A title label 302 may indicate to the user that the user interface 300 is displaying the applications menu of the computing platform 104. The user interface 300 may additionally include an application listing 304 of the applications that are available for use on the computing platform 104. In some cases, if there are more applications than can be presented in a single listing, the user interface 300 further includes a tab control 306 or page control 306 from which multiple pages of applications may be selected for viewing on the display 138.

Each application may be represented by an entry in the application listing 304. In an example, each application may include an application name (e.g., power flow, travel link, FORDPASS, etc.) and an icon with an image associated with the application. To invoke one of the applications, the user may select the item corresponding to the desired application from the application listing 304.

In some cases, vehicle applications 110 installed to the computing platform 104 may appear in the application listing 304 in the same manner as mobile applications 170 installed to the mobile device 152 and accessible via the device link interface 172. In other cases, a visual distinction may be made in the application listing 304.

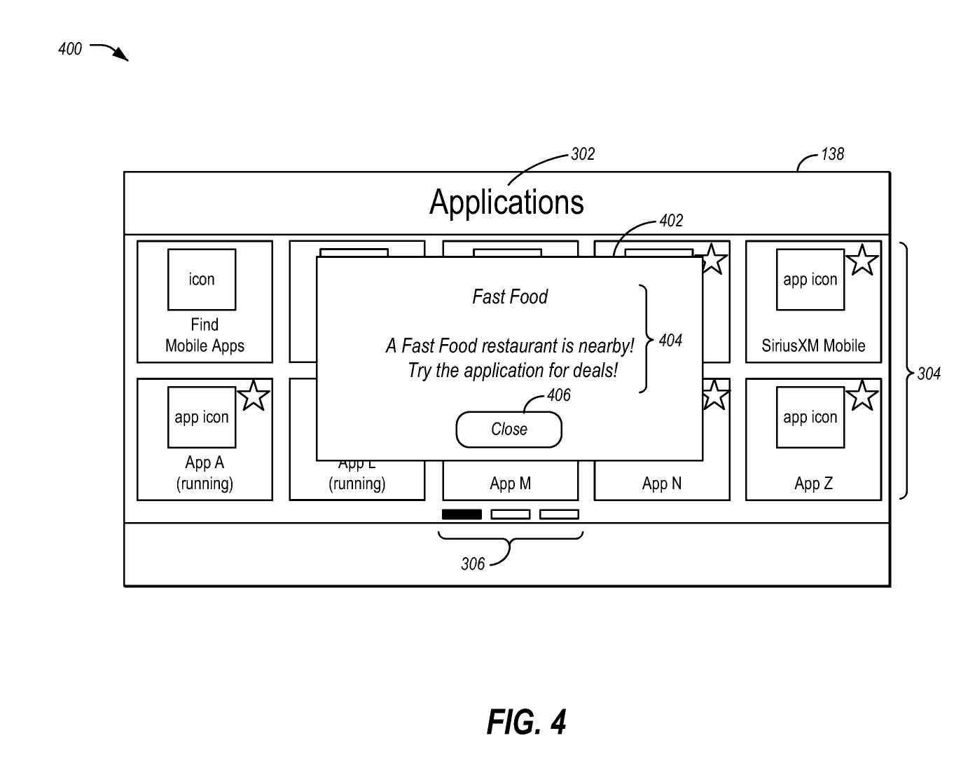

FIG. 4 illustrates an example user interface 400 of the computing platform 104 displaying a preview application alert 402. In an example, the alert 402 may be displayed responsive to the computing platform 104 receiving an indication that a preview application 176 is available that may be of interest to the user. The alert 402 may include a text description 404 explaining what the suggested preview application 176 is, as well as a close control 406 that, when selected, allows the alert 402 to be dismissed by the user.

Generally, the alert 402 may be provided responsive to a defined context of the preview application 176 matching to the current vehicle context 178. As shown, an alert 402 is shown for a “Fast Food” preview application 176. For instance, a Fast Food application may define a predefined proximity from a popular fast food restaurant within which the Fast Food application is to be recommended to the user (e.g., a two-mile radius). If the vehicle context 178 for the vehicle 102 indicates that the user is within the predefined proximity, the telematics control unit 144 may inform the computing platform 104 to provide an alert of a preview application 176 on the display 138 of the computing platform 104, e.g., within the “Apps” tab of the vehicle HMI. It should be noted that this is but one example and there are many other examples of possible preview applications 176 that may be recommended.

In another example, the user may be driving a Ford vehicle, but does not have FORDPASS downloaded to the mobile device 152. The telematics control unit 144 may inform the computing platform 104 to present a sample of the FORDPASS application's features and allow for the user to download FORDPASS from an app store onto the mobile device 152.

As yet another example, the user may already have two existing fast food applications installed to the mobile device 152. The telematics control unit 144 may recognize this and suggest a preview application 176 with vehicle context 178 as being in a fast food category.

As a further example, a windshield wiper of the vehicle 102 may be estimated as being worn according to vehicle 102 mileage data. The telematics control unit 144 may recognize this according to the vehicle 102 mileage and may advertise a preview application 176 having vehicle context 178 relating to the mileage that is designed to direct the user to go to a dealer or a car repair shop.

Or, the vehicle 102 may be identified as being low on fuel. The telematics control unit 144 may recognize this and may advertise a preview application 176 associated with vehicle context 178 of low fuel conditions to lead the customer to a gas station.

Yet further, the vehicle 102 may access the calendar of the user from the mobile device 152 and may recognize that the user has a lunch appointment with no location chosen. The telematics control unit 144 may recognize this and may advertise a preview application 176 associated with lunch and the location of the vehicle 102.

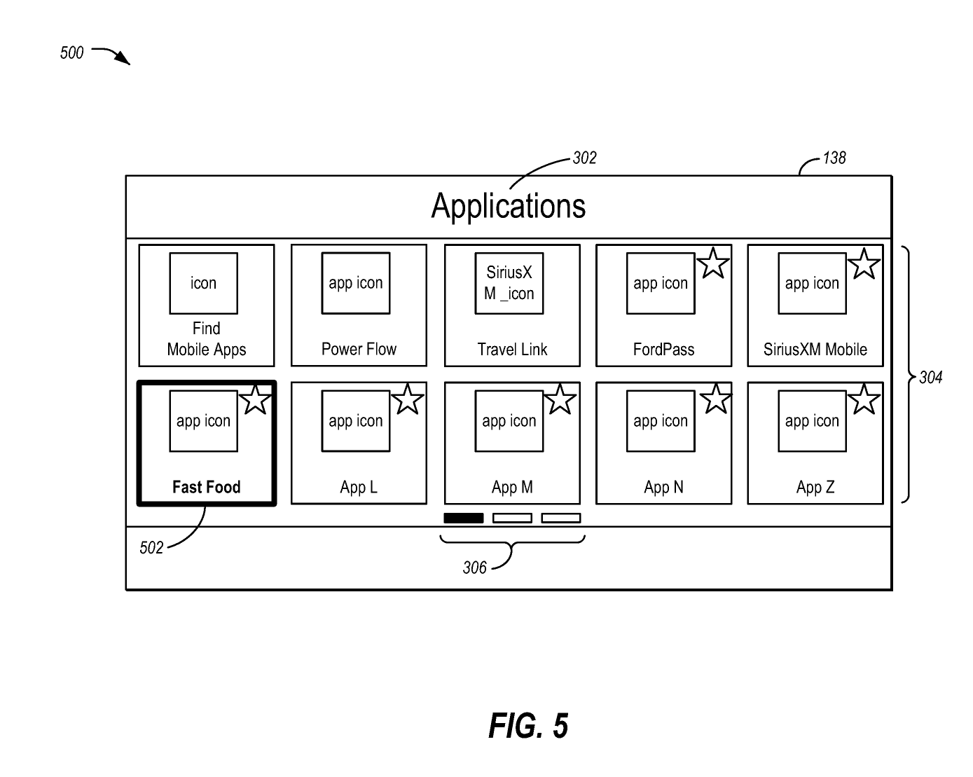

FIG. 5 illustrates an example user interface 500 of the computing platform 104 displaying a preview application 176 in the applications list view. To continue the “Fast Food” example from FIG. 4, in FIG. 5 the “Fast Food” preview application 176 in the application listing 304 is displayed in a different manner to distinguish the preview application 176 being recommended from the other application in the application listing 304. As shown, the “Fast Food” preview application 176 is displayed with a larger border as compared to the borders around the other applications in the application listing 304. This is only an example, and other different or highlighted representations of the preview application 176 being distinguished may be used.

To invoke the preview application 176, the user may select the preview application 176 from the application listing 304. In one example, the display 138 may be a touch screen display, and the user may touch the preview application 176 list item in the application listing 304. In another example, the computing platform 104 may respond to a voice command from the user to open the “Fast Food” application, e.g., by the user requesting the preview application 176 by name. In yet a further example, the user may utilize arrows or other hard buttons to navigate a selection in the application listing 304, and may further press an “OK” or select button to invoke the selection application from the application listing 304.

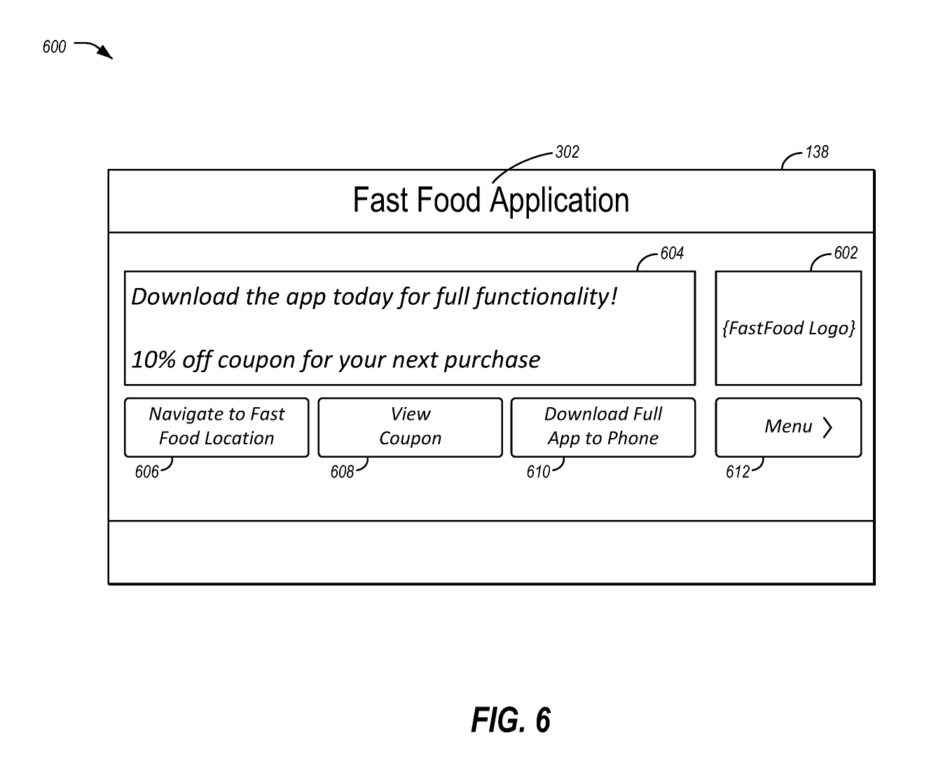

FIG. 6 illustrates an example user interface 600 of the preview application 176 provided by the computing platform 104. In an example, the user interface 600 may be displayed responsive to invocation of the preview application 176. As shown, the user interface 600 of the preview application 176 includes the title label 302 that indicates the name of the preview application 176 that is being executed. Moreover, the user interface 600 may also include an icon 602 of the preview application 176 to provide a further visual indication of the specific preview application 176 being executed.

As shown, the user interface 600 of the preview application 176 includes a description field 604 in which content regarding the preview application 176 may be displayed. This content may include, for example, a suggestion to download the full version of the preview application 176. This content may also include information regarding current offers available for customers.

The preview application 176 may further provide for at least a subset of the functionality of the full mobile application 170. For instance, the preview application 176 may include a navigate control 606 that, when selected, causes the computing platform 104 to provide navigation from a current location of the vehicle 102 to the location of the Fast Food restaurant, and a view coupon control 608 that, when selected, causes the computing platform 104 to provide a coupon (e.g., savings on a next purchase at the Fast Food restaurant). The preview application 176 may also provide a full application control 610 that, when selected, causes the computing platform 104 to indicate to the mobile device 152 to download the full mobile application 170 version of the preview application 176. Also as shown, the preview application 176 may include a menu control 612 that, when selected, causes the computing platform 104 to display other functions available via the preview application 176.

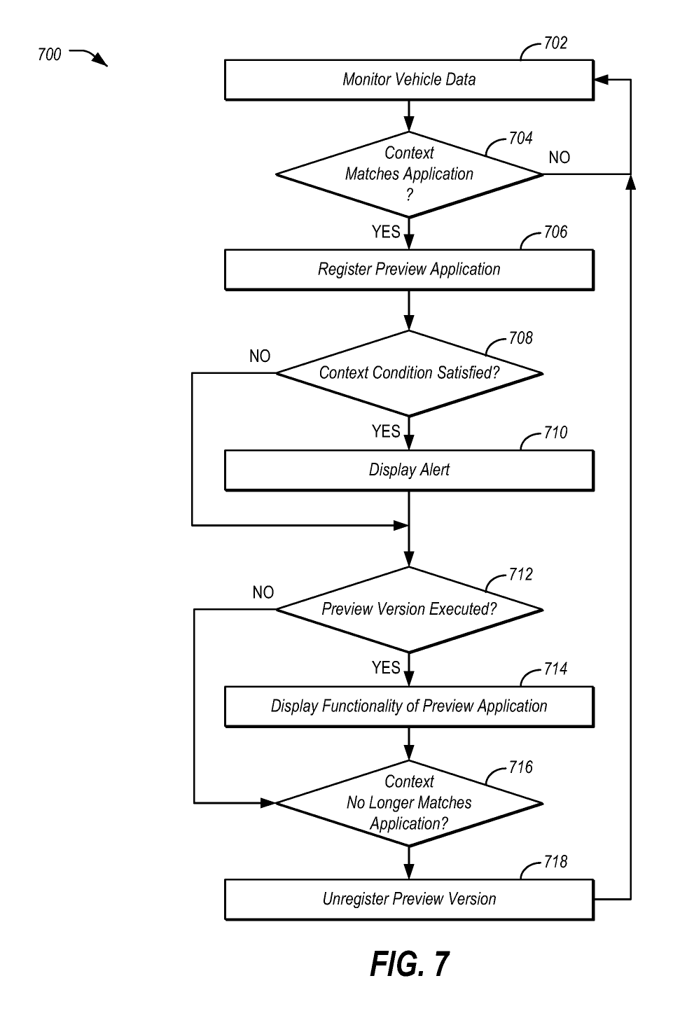

FIG. 7 illustrates an example process 700 for providing a preview application 176 by the computing platform 104. In an example, the process 700 may be performed by the computing platform 104 of the system 100 described in detail above.

At operation 702, the computing platform 104 monitors vehicle data. In an example, computing platform 104 receives device data from the mobile device 152. The device data may include information such as a listing of applications that are currently downloaded to the mobile device 152, available space on the mobile device 152, and operating system or other compatibility information of the mobile device 152. The computing platform 104 may receive the information and may add additional contextual information to the received data. As some examples, the computing platform 104 may include a current location of the vehicle 102 (e.g., determined via the global positioning system module 146), a fuel level of the vehicle (e.g., determined based on data retrieved via the vehicle network 142), a current time, and other vehicle status information (e.g., diagnostic codes, maintenance that is due according to mileage or wear, etc.).

At 704, the computing platform 104 determines whether the vehicle context 178 matches context information of the preview application 176. In an example, the telematics server 162 may utilize the vehicle context 178 to identify preview applications 176 that are compatible with the mobile device 152 connected to the computing platform 104 of the vehicle 102. In another example, the telematics server 162 may utilize the vehicle context 178 to identify preview applications 176 that relate to a store or vendor within geographic proximity to the current location of the vehicle 102. In yet a further example, the telematics server 162 may utilize the vehicle context 178 to identify preview applications 176 that relate to a current need of the vehicle 102, such as that the vehicle 102 requires fuel. These identified preview applications 176 may be sent by the telematics server 162 to the vehicle 102.

The computing platform 104 registers the preview application 176 at 706. In an example, the preview applications 176 that match the current vehicle context 178 may be registered with the computing platform 104. Once registered, the preview applications 176 may be available for use, and may appear in the application listing 304.

At 708, the computing platform 104 determines whether the vehicle context 178 of the preview application 176 matches that of current conditions. For instance, if the vehicle context 178 for the vehicle 102 indicates that the user is within the predefined proximity, the telematics control unit 144 may inform the computing platform 104 to provide an alert of a preview application 176 on the display 138 of the computing platform 104, e.g., within the “Apps” tab of the vehicle HMI. If there is a match, control passes to operation 710 to display an alert. An example alert 402 is shown in the user interface 400.

At 712, the computing platform 104 determines whether the preview application 176 is executed. In an example, the user may invoke the preview application 176 by selection from the application listing 304 or via voice command of speaking a name of the preview application 176. In another example, the alert 402 may provide an option for invoking the preview application 176 from the alert 402 itself.

At operation 714, the computing platform 104 displays functionality of the preview application 176. An example preview application 176 is discussed above with respect to the user interface 600.

At 716, the computing platform 104 determines whether the vehicle context 178 no longer matches context information of the preview application 176. For instance, if the vehicle context 178 for the vehicle 102 indicates that the user is no longer within the predefined proximity required for use of the preview application 176, control may pass to operation 718 to unregister the preview application 176. If no unregistration is required, control passes to operation 702. Once unregistered, the preview application 176 may no longer be available for use. In some examples, if the preview application 176 is currently being used while the vehicle context 178 no longer matches context information of the preview application 176, the preview application 176 may be allowed to continue to execute until the preview application 176 is dismissed, after which the preview application 176 may be unregistered. After operation 718, control returns to operation 702.

Computing devices described herein generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A system comprising:
a transceiver; and
a computing platform of a vehicle, programmed to
display a user interface of applications executed by a mobile device connected via the transceiver,
execute a preview application including a function to download a full version of the application to the mobile device, and
responsive to selection of the function, send a request to the mobile device to download the full version of the application,
wherein the preview application includes only a portion of the functionality of the full version of the application.

2. The system of claim 1, wherein the preview application is associated with contextual information specifying when the preview application is recommended, and the computing platform is further programmed to display an alert recommending the preview application responsive to vehicle context matching the contextual information.

3. The system of claim 2, wherein the alert includes a control that, when selected, invokes the preview application.

4. The system of claim 2, wherein the computing platform is further programmed to:
register the preview application responsive to the contextual information of the preview application matching the vehicle context; and
unregister the preview application responsive to the contextual information of the preview application no longer matching the vehicle context.

5. The system of claim 2, wherein the vehicle context includes vehicle location, and a listing of applications downloaded to the mobile device.

6. (canceled)

7. The system of claim 1, wherein the computing platform is further programmed to download the preview application from a remote server.

8. A method comprising:
registering a preview application installed to a vehicle responsive to contextual information of the preview application matching vehicle context including vehicle location and listing of applications downloaded to a mobile device connected to the vehicle; and
responsive to selection of a function of the preview application to download a full version of the application, sending a message to the mobile device to install the full version to the mobile device;
wherein the preview application includes only a portion of the functionality of the full version of the application.

9. The method of claim 8, further comprising unregistering the preview application responsive to the contextual information of the preview application no longer matching the vehicle context.

10. The method of claim 9, further comprising blocking unregistration of the preview application responsive to user selection to keep the preview application.

11. The method of claim 9, further comprising deleting the preview application responsive to unregistering the preview application.

12. The method of claim 8, further comprising downloading the preview application from a remote server.

13. The method of claim 8, further comprising displaying an alert recommending the preview application responsive to the vehicle context matching the contextual information.

14. The method of claim 13, further comprising invoking the preview application responsive to selection of a control of the alert.

15. (canceled)

16. A non-transitory computer-readable medium comprising instructions that, when executed by a processor of a computing platform, cause the computing platform to:
download a preview application from a remote server to the computing platform;
register the preview application to a vehicle responsive to contextual information of the preview application matching vehicle context including vehicle location and a listing of applications installed to a mobile device connected to the vehicle;
display a listing including both applications installed to the mobile device and preview applications installed to the computing platform; and
responsive to selection of a function of the preview application to download a full version of the application, send a message to the mobile device to install the full version to the mobile device;
wherein the preview application includes only a portion of the functionality of the full version of the application.

17. The medium of claim 16, further comprising instructions that, when executed by the processor of the computing platform, cause the computing platform to unregister the preview application responsive to the contextual information of the preview application no longer matching the vehicle context.

18. The medium of claim 16, further comprising instructions that, when executed by the processor of the computing platform, cause the computing platform to display an alert recommending the preview application responsive to the vehicle context matching the contextual information.

19. The medium of claim 18, further comprising instructions that, when executed by the processor of the computing platform, cause the computing platform to invoke the preview application responsive to selection of a control of the alert.

20. (canceled)
